(19) United States
(12) Patent Application Publication
(10) Pub. No.: US 2021/0061604 A1
(43) Pub. Date: Mar. 4, 2021

(54) DETERMINING ORIENTATION OF A SUBSTRATE

(71) Applicant: HEWLETT-PACKARD DEVELOPMENT COMPANY, L.P., Spring, TX (US)

(72) Inventors: Brian Carvajal, Sant Cugat del Valles (ES); Francisco Javier Rodriguez, Sant Cugat del Valles (ES); Roger Terradellas, Sant Cugat del Valles (ES)

(73) Assignee: HEWLETT-PACKARD DEVELOPMENT COMPANY, L.P., Spring, TX (US)

(21) Appl. No.: 16/977,728

(22) PCT Filed: Mar. 16, 2018
(86) PCT No.: PCT/US2018/022944

§ 371 Date: Sep. 2, 2020

(51) Int. Cl. B65H 16/10; B41J 15/16; B65H 18/02; B65H 23/195

(52) U.S. Cl. CPC B65H 16/10; B65H 23/195; B65H 18/02; B41J 15/16

(57) ABSTRACT

An example apparatus is disclosed for transporting a substrate through a printing device. The apparatus comprises a shaft to carry the substrate, a motor to rotatably drive the shaft, a motor driver to provide a control signal to the motor to drive the shaft, a transport arrangement to draw the substrate from the shaft, and a controller to cause the motor driver to drive the shaft at a predetermined rotational speed, to cause the transport arrangement to apply tension to the substrate, and to detect a winding direction of the substrate on the shaft based on the control signal.

### BACKGROUND

A printing device may apply print agent to a substrate. The substrate may be provided in the form of a roll that is mounted on a shaft of the printing device. The shaft may be driven by a motor so as to rotate the substrate roll to facilitate conveying the substrate through the printing device.

### BRIEF DESCRIPTION OF DRAWINGS

Examples will now be described, by way of non-limiting example, with reference to the accompanying drawings, in which:

FIG. 1 is a simplified schematic of an example of apparatus for transporting a substrate through a printing device;

FIG. 2 is a simplified schematic of an example of a shaft, transport arrangement and substrate;

FIG. 3 is a simplified schematic of an example of a shaft, transport arrangement and substrate;

FIG. 4 is a flow chart of an example of a method of determining a winding direction of a roll of print media; and

FIG. 5 is a simplified schematic of an example of a conveyance apparatus for conveying print media through a printing apparatus.

### DETAILED DESCRIPTION

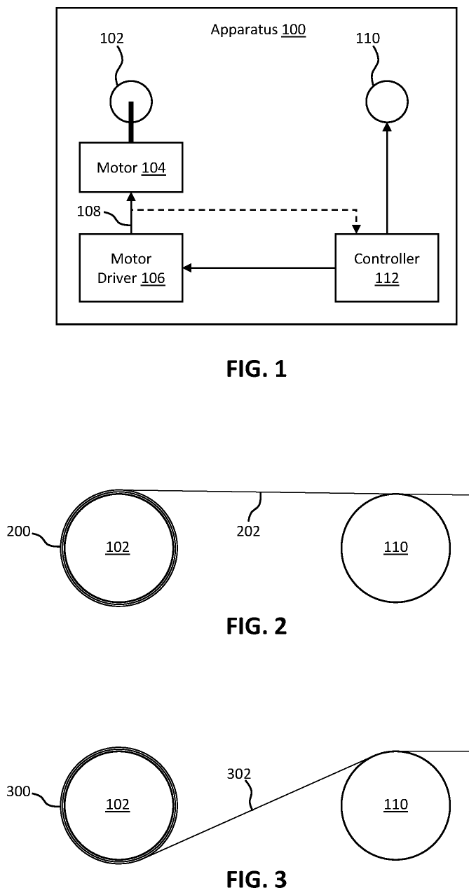

FIG. 1 is a simplified schematic of an example of apparatus 100, for example apparatus for transporting a substrate through a printing device. The apparatus 100 comprises a shaft 102 to carry the substrate (not shown). The substrate may be for example in the form of a roll. The apparatus 100 also comprises a motor 104 to rotatably drive the shaft. In some examples, the motor 104 may drive the shaft so as to rotate the roll of the substrate whilst the substrate is being fed through the apparatus 100. This may facilitate transport of the substrate through the apparatus 100.

The apparatus 100 includes a motor driver 106 to provide a control signal 108 to the motor to drive the shaft. In some examples, the control signal 108 is a pulse width modulated (PWM) signal. In some examples, the motor 104 and motor driver 106 together comprise a servomechanism which may receive an instruction to rotate the shaft 102 at a predetermined rotational speed.

The apparatus 100 further comprises a transport arrangement 110 to draw the substrate from the shaft. In some examples, the transport arrangement comprises one or more rollers, conveyors and/or other apparatus to convey the substrate through the apparatus 100. The apparatus 100 may include one or more functions, and the transport arrangement 110 may convey the substrate to the functions. In an example, the apparatus 100 may include a printing function to apply print agent to the substrate.

The apparatus 100 also comprises a controller 112 to cause the motor driver 106 to drive the shaft 102 at a predetermined rotational speed. For example, the controller 112 may cause the motor driver 106 to drive or control the motor 104 using the control signal 108. The controller 112 may also cause the transport arrangement 110 to apply tension to the substrate. For example, the transport arrangement 110 may be controlled to attempt to draw the substrate through the apparatus 100. The controller 112 is also to detect a winding direction of the substrate on the shaft based on the control signal 108. For example, the controller 112 receives the control signal 108 or an indication of the control signal 108 and may use this to determine the winding direction.

For example, the motor driver 106 may drive the motor 104 to maintain the shaft 102 at a constant rotational speed, and subsequently the transport arrangement 110 may be controlled to apply tension to the substrate. As a result, the motor driver 106 may change the control signal 108 to change the torque output of the motor 104 and thus maintain the shaft 102 at a substantially constant rotational speed. The controller 112 may detect the change in the control signal and use this to determine the winding direction of the substrate. For example, the transport arrangement may be controlled to attempt to draw the substrate through the apparatus 100. The motor driver 106 may adjust the control signal 108 such that, for example, the duty cycle of the PWM control signal either increases or decreases, and the increase or decrease may indicate the winding direction.

In some examples, the predetermined rotational speed is stationary, such that the controller 112 is to cause the motor driver 106 to drive the shaft 102 to remain stationary. In such examples, the controller 112 may detect the winding direction of the substrate on the shaft 102 based on the sign of the control signal 108.

FIG. 2 illustrates an example of a shaft 102, transport arrangement 110 and a substrate 202. A roll 200 of a substrate 202 is mounted on the shaft 102 such that the roll has a winding arranged in a first direction. In this example, as shown, the substrate 202 may be drawn through the apparatus 100 by the transport arrangement 110 from an upper side of the shaft 102. In FIG. 3 illustrates an opposite example where a roll 300 substrate 302 has a winding arranged in a second direction, such that the substrate 302 is drawn from a roll 300 on the shaft 102 from a lower side of the shaft 102. In some examples, the controller 112 may determine, from the control signal 108, which direction the roll of substrate is mounted on the shaft 102, e.g. whether it is oriented as shown in FIG. 2 or as shown in FIG. 3.

In some examples, determination of the winding direction of the substrate may be performed after the roll of substrate is installed on the shaft 102. In some examples, an operator of the apparatus 100 may take an end of the substrate and provide it to the transport arrangement 110. In one example, the transport arrangement 110 may be controlled to attempt to draw the substrate through the apparatus 100 while the shaft 100 is controlled to remain substantially stationary. This may cause the substrate to slip on the transport arrangement 110. As a result, this may in some examples aid alignment of the substrate on the transport arrangement 110, e.g. by reducing or removing skew, and the controller 112 may simultaneously determine the winding direction from the sign of the control signal 108.

In some examples, the controller 112 is to detect the winding direction of the substrate on the shaft 102 when a property of the control signal 108 is beyond a threshold. That is, for example, depending on the property of the control signal and the threshold, the winding direction may be detected when the property is above a threshold, or when the property is below the threshold. For example, the threshold may be an amplitude and/or duty cycle of the control signal 108. In this way, for example, the controller 112 may not attempt to determine the winding direction whilst the substrate roll is being installed on the shaft 102, whilst the operator is providing the end of the substrate to the transport arrangement 110, and/or before the transport arrangement 110 begins attempting to draw the substrate through the apparatus. These actions may result in a control signal 108 that is below the threshold.

In some example, the controller 112 is to cause the motor 104 (e.g. via the motor driver 106) to drive the shaft 102 to feed the substrate to the transport arrangement 110 based on the winding direction. For example, the shaft 102 may be driven to rotate in the same direction as the winding direction, so as to reduce the tension in the substrate compared to the case where the shaft 102 is not driven.

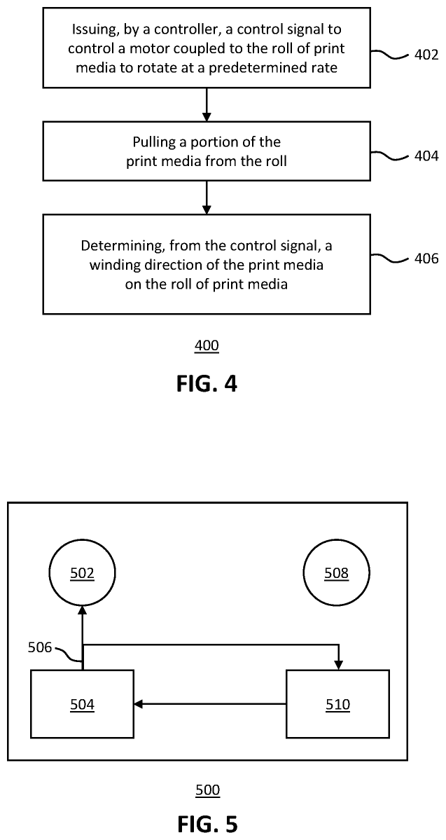

FIG. 4 is a flow chart of an example of a method 400, such as for example a method of determining a winding direction of a roll of print media. The method comprises, in block 402, issuing, by a controller, a control signal to control a motor coupled to the roll of print media to rotate at a predetermined rate. For example, the controller may control the motor to rotate at a predetermined speed, remain in a predetermined position and/or provide a predetermined torque in response to an instruction. The motor controller and motor may be, in some examples, a servomechanism. In some examples, the predetermined rate is zero, i.e. stationary.

The method 400 includes, in block 404, pulling a portion of the print media from the roll. This may in some examples apply a torque to the roll of print media, which may be counteracted by the motor controller, which attempts to keep the roll of print media rotating at the predetermined rate. In some examples, the portion of print media may be pulled by a conveyance apparatus that conveys the print media through a device such as a printing device, and may also be motorized.

The method 400 also includes, in block 406, determining, from the control signal, a winding direction of the print media on the roll of print media. Thus in some examples a property of the control signal, such as for example a sign of the control signal, change in the control signal (e.g. duty cycle or amplitude) when the portion of print media is pulled, and/or any other property may be used to determine the winding direction. For example, the winding direction may determine the sign of the control signal, or the direction of the change to the control signal. The control signal may in some examples be a PWM signal.

In essence, the controller is to issue a control signal to maintain the motor at a predetermined speed, and a pulling force is exerted on the substrate by a pulling mechanism separate from the motor, e.g., by the transport arrangement 110. As a consequence of the pulling force, the control signal issued by the controller needs to be modified to maintain the predetermined speed and, by analysing the control signal, the winding direction of the roll may be determined.

In some examples, the predetermined rate is zero. Thus, for example, determining the winding direction may comprise determining the winding direction from a sign of the control signal.

In some examples, determining the winding direction comprises determining the winding direction when a duty cycle of the control signal is above a threshold. For example, the control signal may be a PWM signal with a duty cycle, and a signal with a duty cycle below the threshold may indicate that the control signal is being applied not because the media is being pulled as in block 404, but for the reasons, such as for example during installation of the print media, or when the apparatus is idle, whereby minor forces on the roll of print media may result in a control signal with duty cycle below the threshold. Alternatively, the media may be pulled in block 404, but this may not cause any significant torque to be applied to the roll of print media until any slack is taken up.

FIG. 5 is a simplified schematic of an example of a conveyance apparatus 500, for example for conveying print media through a printing apparatus. The conveyance apparatus 500 comprises a rotatable support 502 for a roll of print media, and a device 504 to generate a signal 506 for controlling the support 502 to a predetermined rotational speed. For example, the rotation may be along an axis of the support 502, which may be for example a cylindrical shaft or elongate article. The signal 506 may for example be a PWM signal with a sign that is indicative of a direction in which torque is being applied to the support 502.

The apparatus 500 includes an output roller drivable to draw print media from the support 502. This may in some examples cause tension in the print media and thus apply a torque to the support 502 in addition to any torque caused by the device 504 and signal 506.

The apparatus 500 further comprises a determining device 510 to determine the orientation of the roll of print media from the signal. For example the determining device 510 may sense a sign, change in magnitude or other property and derive the winding direction therefrom.

In some examples, the predetermined rotational speed is zero or substantially zero, and thus the control signal 506 is applied to the support 502, which may include an electric motor, to keep the support from rotating. The support 502 or a motor therein may in some examples provide a feedback signal to the device 504 to allow the device 504 to control the rotation of the support 502. Thus, in some examples, the determining device 504 is to determine the orientation of the roll of print media from a sign of the signal.

In some examples, the determining device 504 is to determine the orientation (e.g. winding direction) of the roll of print media when a duty cycle of the signal is above a threshold.

In some examples, when the orientation or winding direction of a roll of substrate or print media is determined, the roll of print media may be rotated in a certain direction so as to supply the substrate or print media to an apparatus, and/or to control the tension of the print media to a desired level. Knowledge of the orientation or winding direction may in some examples enable the roll of print media to be rotated in the correct direction to provide a desired result, such as supply of the substrate or media or desired tension.

In some examples, the orientation or winding direction may be determined whilst the substrate or print media is slipping on a roller or other transport or conveyance apparatus in a procedure to remove skew or otherwise correct the alignment of the substrate or print media.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. Apparatus for transporting a substrate through a printing device, the apparatus comprising:
a shaft to carry the substrate;
a motor to rotatably drive the shaft;
a motor driver to provide a control signal to the motor to drive the shaft;
a transport arrangement to draw the substrate from the shaft; and
a controller to cause the motor driver to drive the shaft at a predetermined rotational speed, to cause the transport arrangement to apply tension to the substrate, and to detect a winding direction of the substrate on the shaft based on the control signal.

2. The apparatus of claim 1, wherein the predetermined rotational speed is stationary, such that the controller is to cause the motor driver to drive the shaft to remain stationary.

3. The apparatus of claim 2, wherein the controller is to detect the winding direction of the substrate on the shaft based on the sign of the control signal.

4. The apparatus of claim 1, wherein the controller is to detect the winding direction of the substrate on the shaft when a property of the control signal is beyond a threshold.

5. The apparatus of claim 4, wherein the controller is to detect the winding direction of the substrate on the shaft when a duty cycle of the control signal is above a threshold.

6. The apparatus of claim 1, wherein the controller is to cause the motor to drive the shaft to feed the substrate to the transport arrangement based on the winding direction.

7. A method of determining a winding direction of a roll of print media, the method comprising:
issuing, by a controller, a control signal to control a motor coupled to the roll of print media to rotate at a predetermined rate;
pulling a portion of the print media from the roll; and
determining, from the control signal, a winding direction of the print media on the roll of print media.

8. The method of claim 7, wherein the predetermined rate is zero.

9. The method of claim 8, wherein determining the winding direction comprises determining the winding direction from a sign of the control signal.

10. The method of claim 7, wherein determining the winding direction comprises determining the winding direction when a duty cycle of the control signal is above a threshold.

11. A conveyance apparatus for a printing apparatus, the conveyance apparatus comprising:
a rotatable support for a roll of print media;
a device to generate a signal for controlling the support to a predetermined rotational speed; and
an output roller drivable to draw print media from the support;
a determining device to determine the orientation of the roll of print media from the signal.

12. The conveyance apparatus of claim 11, wherein the predetermined rotational speed is substantially zero.

13. The conveyance apparatus of claim 12, wherein the determining device is to determine the orientation of the roll of print media from a sign of the signal.

14. The conveyance apparatus of claim 11, wherein the signal is a pulse width modulated (PWM) signal.

15. The conveyance apparatus of claim 14, wherein the determining device is to determine the orientation of the roll of print media when a duty cycle of the signal is above a threshold.
